(19) United States
(12) Patent Application Publication
(10) Pub. No.: US 2019/0224689 A1
(43) Pub. Date: Jul. 25, 2019

(54) TUNABLE INSULATOR-BASED DIELECTROPHORESIS (IDEP) WITH MEMBRANE VALVES

(71) Applicants: Alexandra Ros, Phoenix, AZ (US); Daihyun Kim, Tempe, AZ (US); Jinghui Luo, Covina, CA (US); Mian Yang, Chandler, AZ (US)

(72) Inventors: Alexandra Ros, Phoenix, AZ (US); Daihyun Kim, Tempe, AZ (US); Jinghui Luo, Covina, CA (US); Mian Yang, Chandler, AZ (US)

(21) Appl. No.: 16/317,481

(22) PCT Filed: Jul. 12, 2017
(86) PCT No.: PCT/US2017/041708

§ 371 Date: Jan. 11, 2019

Related U.S. Application Data
(60) Provisional application No. 62/361,858, filed on Jul. 13, 2016.

(51) Int. Cl. B03C 5/00; G01N 27/447; B03C 5/02

(52) U.S. Cl. CPC B03C 5/005; B03C 2201/26; B03C 5/026; G01N 27/447

(57) ABSTRACT

Methods and systems are described for tuning an electrical field gradient for insulator-based di electrophoresis (iDEP). A fluidic layer defines a fluidic channel adjacent to a substrate. A deformable membrane is positioned adjacent to the fluidic channel. An actuator controllably causes the deformable membrane to deflect into the fluidic channel restricting a fluidic flow in the fluidic channel. A control system is configured to tune an electrical field gradient by operating the actuator to adjust a magnitude of the deflection of the deformable membrane into the fluidic channel.

### RELATED APPLICATIONS

This application claims the benefit of U.S. Provisional Patent Application No. 62/361,858, filed Jul. 13, 2016, and entitled “TUNABLE INSULATOR-BASED DIELECTROPHORESIS (IDEP) WITH MEMBRANE VALVES,” the entire contents of which is incorporated herein by reference.

### BACKGROUND

The present invention relates to methods and systems for performing insulator-based dielectrophoresis (iDEP).

### SUMMARY

Insultator-based dielectrophoresis (iDEP) has been utilized for the manipulation of particles, cells, and even organelles in the past. iDEP devices employing insulating post arrays, constrictions, or other geometrical features for separation, preconcentration, and fractionation are hampered by the fact that dielectrophoretic forces scale in a predetermined manner dependent upon the designed geometry. While dielectrophoretic forces can generally be augmented by applying larger electric potentials, analytes may suffer degradation upon the application of large DC potentials.

Various embodiments of the invention described herein circumvent these limitations by using a tunable constriction to induce iDEP for biological particles. A thin membrane actuator layer (control layer) and a fluidic channel are separated by a thin membrane, which can be actuated pneumatically through the control layer. Upon the application of a voltage across the fluidic channel and during the deflection of the thin membrane, the electric field gradient around the membrane becomes imhomogeneous and can be tuned by the amount of deflection. This tunable mechanism may be used, for example, with polystyrene particles, liposomes, and mitochondria or biomolecules such as DNA and proteins. The applications of this tunable device reach from particle trapping, over fractionation, and preconcentration applications.

In one embodiment, the invention provides a system for performing insulator-based dielectrophoresis. The system includes a fluidic layer defining a fluidic channel adjacent to a substrate. A deformable membrane is positioned adjacent to the fluidic channel. An actuator controllably causes the deformable membrane to deflect into the fluidic channel restricting a fluidic flow in the fluidic channel. A control system is configured to tune an electrical field gradient by operating the actuator to adjust a magnitude of the deflection of the deformable membrane into the fluidic channel.

In some embodiments, the system further includes a control layer positioned adjacent to the fluidic layer and including a control channel formed in the control layer. In some such embodiments, the actuator includes a pneumatic pump coupled to the control channel and configured to controllably cause the deformable membrane to deflect into the fluidic channel by adjusting the pneumatic pressure within the control channel.

Other aspects of the invention will become apparent by consideration of the detailed description and accompanying drawings.

### BRIEF DESCRIPTION OF THE DRAWINGS

FIG. 1 is a block diagram of a control system for regulating insulator-based dielectrophoresis according to one embodiment.

FIG. 2A is a perspective view of a dielectrophoresis system including a fluidic channel that is tunably-regulated by a deflectable membrane by the control system of FIG. 1.

FIG. 2B is a perspective view of the dielectrophoresis system of FIG. 2A from another angle and showing additional details of the structural component layers.

FIG. 3A is a schematic view of the dielectrophoresis system of FIG. 2B showing the membrane in an undeflected state.

FIG. 3B is a schematic view of the dielectrophoresis system of FIG. 2B showing the membrane in a deflected state.

FIG. 4 is a series of schematic diagrams showing the membrane in various degrees of deflection and indicating the effect of deflection on the electrical field gradient in the fluidic channel.

FIG. 5 is a schematic flowchart illustrating a method of manufacturing the dielectrophoresis system of FIG. 2B.

FIG. 6A is schematic view of another example of a dielectrophoresis system with the membrane in an undeflective state and a pillar positioned to obstruct the fluidic channel.

FIG. 6B is a schematic view of the system of FIG. 6A with the membrane in a deflective state creating an adjustable gap in the fluidic channel between the membrane and the pillar.

FIG. 6C is a schematic view of an alternative configuration of the system of FIG. 6A in which negative deflection of the membrane partially pulls the pillar from the fluidic channel creating an adjustable gap in the fluidic channel between the pillar and the substrate.

FIG. 7A is a partially-transparent perspective view of an IDEP system with multiple fluid channels and multiple pressure control channels.

FIG. 7B is an overhead view of the IDEP system of FIG. 7A.

FIG. 7C is an elevation view of the IDEP system of FIG. 7A with no pressure applied to the control channels.

FIG. 7D is an elevation view of the IDEP system of FIG. 7A with different pressures applied to each of the control channels.

FIG. 8 is a graph of electrical field gradient relative to the gap size of the fluid channel for the system of FIG. 7A.

FIGS. 9A through 9D are a series of overhead views of an IDEP system configured and used for polystyrene beads in the fluid channel.

FIGS. 10A through 10D are another series of overhead views of an IDEP system configured and used for larger polystyrene beads in the fluid channel.

FIGS. 11A and 11B are schematic illustrations of an IDEP system configured and used for sorting particles of different sizes.

FIG. 12 is a graph of example liposome sizes.

FIGS. 13A and 13B are overhead views of an IDEP system configured for liposome DEP at the dynamic constriction valve using the liposome sizes of the graph of FIG. 12.

FIGS. 14A through 14D is a series of overhead views of an IDEP system configured and used for DNA DEP.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

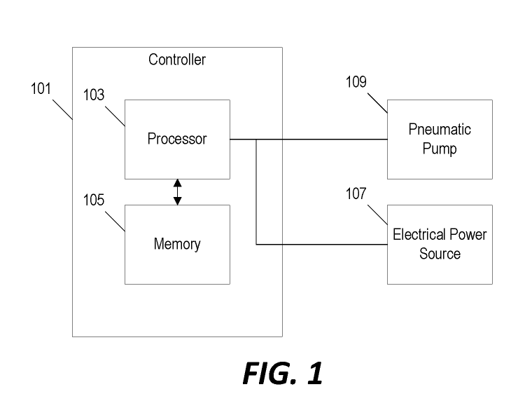

FIG. 1 illustrates a control system for operating a dielectrophoresis system by applying an electrical potential to a fluid channel. The control system includes a controller 101 including a processor 103 and a memory 105. The memory 105 stores instructions that are executed by the processor 103 to provide the operational functionality such as, for example, described below. The processor 103 generates a control signal to an electrical power source 107 that applies an electrical potential to a fluidic channel of the dielectrophoresis system. The processor 103 also generates a control signal for operating a pneumatic pump 109 to provide tunable constriction of the fluidic channel and thereby regulating the electrical field gradient of the dielectrophoresis system as discussed in further detail below.

Although the example of FIG. 1 shows a single controller 101 operating both the pneumatic pump 109 and the electrical power source 107, in some implementations, the separate controllers may be used to operate the pneumatic pump 109 and the electrical power source 107. Similarly, regardless of whether a single controller or multiple controllers are used, in some implementations, the pneumatic pressure and the voltage applied to the fluid channel (as discussed in further detail below) can be controlled and adjusted independently.

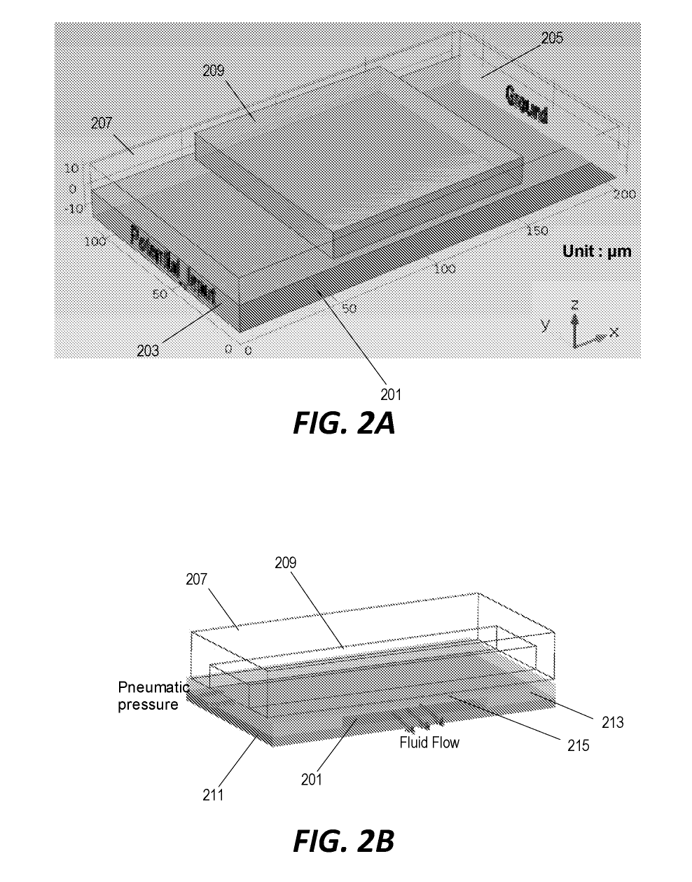

As illustrated in FIG. 2A, the dielectrophoresis system operated by the control system of FIG. 1 includes a fluidic channel 201. A potential is applied to one end 203 of the fluidic channel and the other end 205 is coupled to ground. A control layer 207 is positioned adjacent to the fluidic channel 201 and includes a displacement chamber or control channel 209 that is pneumatically operated by the control system of FIG. 1 as described in further detail below.

As further illustrated in FIG. 2B, a fluid layer 213 is positioned between the control layer 207 and a substrate 211 (e.g., a glass plate). The fluid layer 213 is formed to provide a fluid channel 201 through the fluid layer 213 leaving a thin membrane 215 between the fluid channel 201 and the control channel 209. In the example of FIG. 2B, the control channel 209 is formed linearly through the control layer 207 in a direction perpendicular to the fluidic channel 201. After application of the electrical potential to the fluidic channel 201, fluid flows through the fluidic channel 201 in the direction indicated in FIG. 2B (“fluid flow”). At the same time, the electric field gradient at the portion of the fluidic channel 201 adjacent to the control channel 209 is tuned by pumping or releasing air into the control channel 209 as indicated by the second set of arrows in FIG. 2B (“pneumatic pressure”).

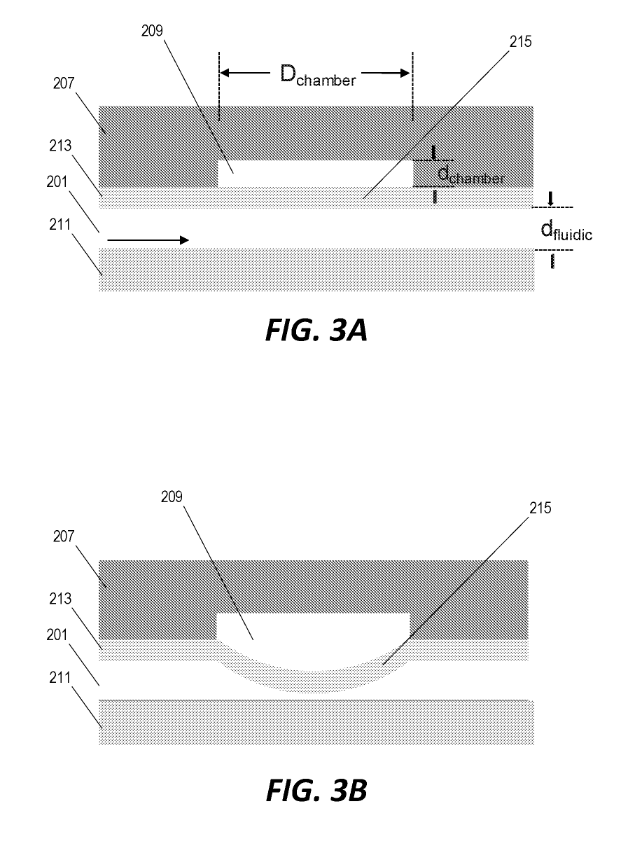

Operating the pneumatic pump to increase the pressure within the control channel 209 causes the membrane to deflect into the fluidic channel 201 thereby constricting the fluidic flow through the fluidic channel 201. FIGS. 3A and 3B illustrate a cross-section of the dielectrophoresis system illustrated in FIG. 2B. In the example of FIG. 3A, the pneumatic pressure applied to the control channel 209 is insufficient to cause deflection of the membrane 215. However, in the example of FIG. 3B, the pneumatic pressure is increased and the membrane 215 deflects downward into the fluidic channel 201. This deflection operates as a valve to constrict fluidic flow through the fluidic channel 201.

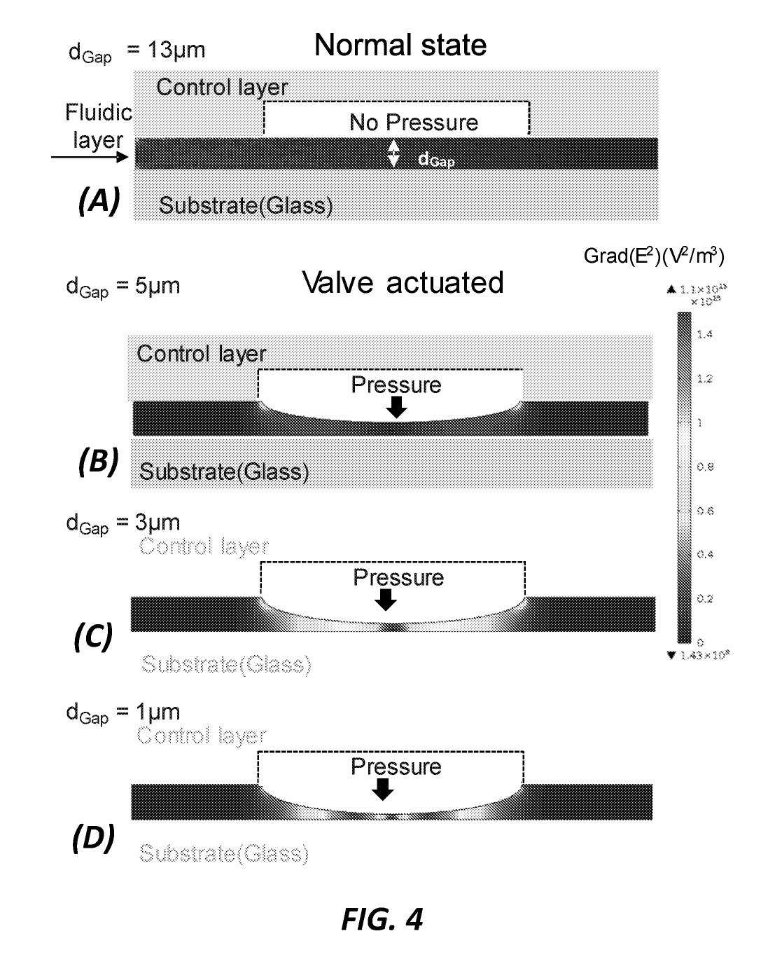

As further illustrated in FIG. 4, tunably constricting the fluid flow through the fluidic channel 201 is used to tunably-regulate the electric field gradient of the system. As shown in example (A) in FIG. 4, when the membrane is not deflected, the electrical field gradient of the fluid within the fluidic channel is generally homogeneous. However, when the membrane is deflected as shown in example (B), it induces a non-uniform electric field gradient. As illustrated in examples (C) and (D) in FIG. 4, the resultant electrical field gradient is further altered as the membrane is deflected further into the fluidic channel and further constricts fluid flow. However, it is noted that, even when the system operates without fluid flow, electrical field gradients will still be created or influenced by the deflection of the membrane.

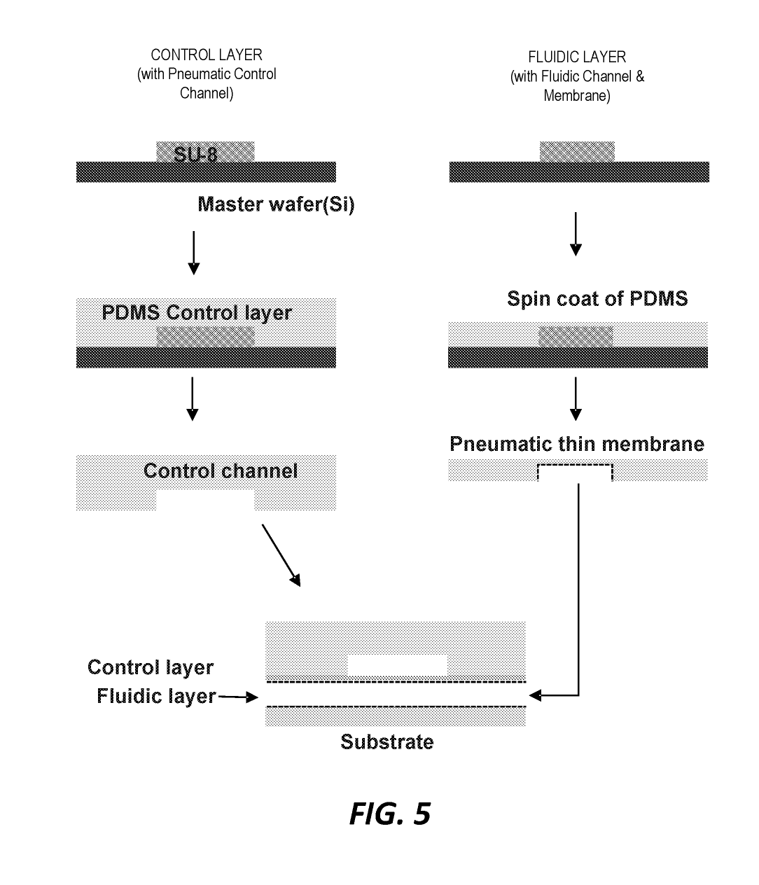

FIG. 5 illustrates a method for manufacturing the multi-layer dielectrophoresis system using a soft lithography method. The control layer 207 is constructed by applying an etch-stop such as, for example, SU-8 on a master wafer (Si) in the shape of the control channel 209. A poly dimethyl-siloxane (PDMS) material is then deposited over the etch-stop to form the control layer. The PDMS is removed from the master wafer leaving the control channel 209 formed in the control layer 207. Similarly, the fluidic layer is formed by first depositing an etch-stop on a master wafer (Si) in the shape of the fluidic channel. A spin coat of PDMS is applied to slightly cover the etch-stop and, when the PDMS material is removed, a fluidic layer including the defined fluidic channel and the deflectable membrane is formed. Although the example of FIG. 5 discusses specific materials, such as PDMS, other materials with other types of elastomeric thin membranes might be used in other implementations.

As further illustrated in FIG. 5, the control layer is coupled to the fluidic layer such that the control channel runs substantially perpendicular to the fluidic channel. Both layers are also coupled to a substrate such as, for example, a glass plate, to complete the structure and to surround the defined fluidic channel. However, in other implementations, other orientations and angles for positioning the control channel relative to the fluidic channel may be used.

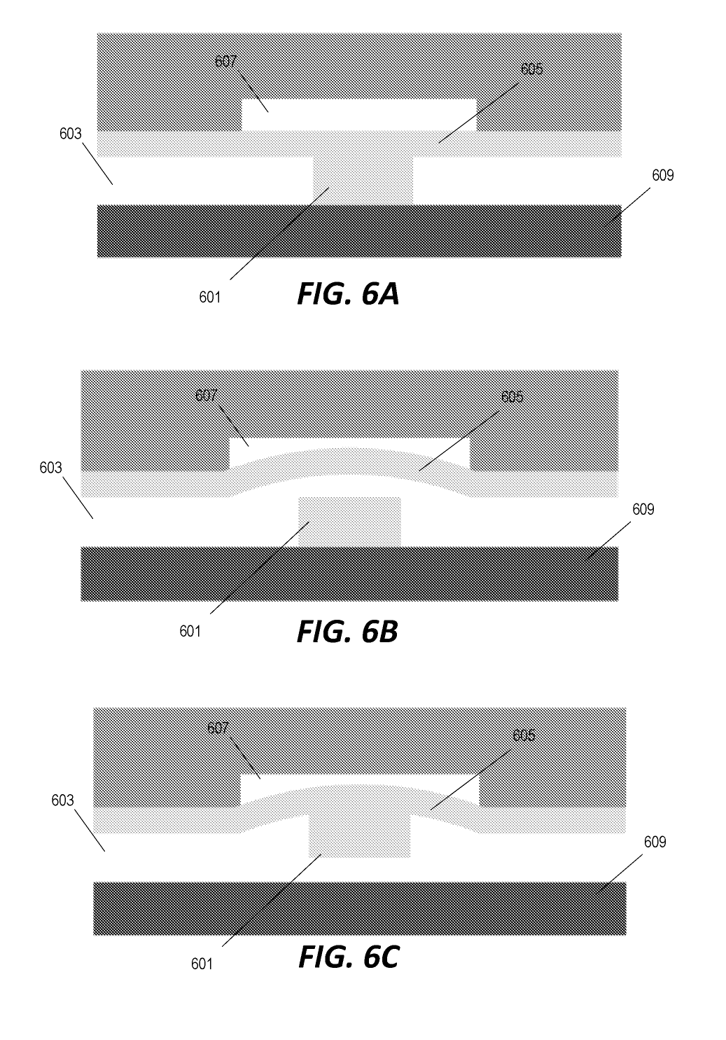

The specific methods and systems described above are only some examples of the potential embodiments of this invention. Other embodiments may include different materials, structural configurations, and components. For example, rather than regulating the pressure within the control channel using a pneumatic pump, the system may include a pin, a lever, or magnetic mechanism to controllably regulate the constriction of the fluidic channel and, thereby, to tune the electric field gradient of the fluidic channel. FIGS. 6A-6C illustrate examples in which a pillar or barrier 601 is formed within the fluidic channel 603. Under normal (e.g., ambient) pressures, the membrane 605 and the pillar 601 may entirely block the fluidic channel 603 as shown in FIG. 6A. Instead of pumping air into the control channel 607 to deflect the membrane 605 by increasing the pneumatic pressure, the pneumatic pump pulls air out of the control channel thereby reducing the pneumatic pressure causing the membrane 605 to deflect upward creating an adjustable gap between the membrane 605 and the pillar 601, as shown in FIG. 6B, or, in implementations where the pillar 601 is affixed to or integral with the membrane 605, creating an adjustable gap between the pillar 601 and the substrate 609, as shown in FIG. 6C.

Furthermore, in other embodiments, the direction and/or the specific arrangement of the control channel relative to the fluid channel may be different. For example, in some embodiments, the dielectrophoresis system may be configured to include multiple parallel fluidic channels. In some implementations that include multiple parallel fluidic channels, a single pressure control channel runs across multiple fluidic channels to simultaneously constrict each fluidic channel. However, in other embodiments, a dielectrophoresis system with multiple parallel fluidic channels can be configured with a separate, individually controllable control “chamber” that regulates the constriction of an individual fluidic channel. Similarly, in some implementations, a dielectrophoresis system may be configured to include multiple control channels positioned across the same fluidic channel.

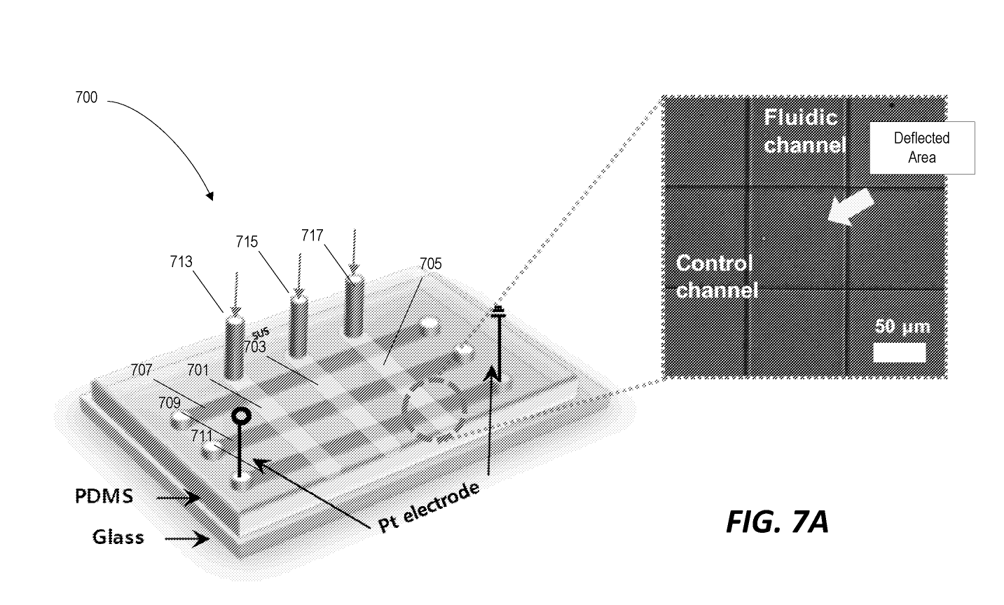

FIGS. 7A, 7B, 7C, and 7D illustrate an example of a dielectrophoresis system 700 that includes three pressure control channels 701, 703, 705 arranged across three fluidic channels 707, 709, 711. Each fluidic channel 707, 709, 711 is formed in a PDMS material above a glass substrate as illustrated in FIG. 7A. The fluidic channels 707, 709, 711 run parallel to each other and each extends between a respective pair of platinum electrodes. The three control channels 701, 703, 705 are formed in the PDMS material above the fluidic channels 707, 709, 711 as illustrated in FIGS. 7C and 7D. As shown in FIGS. 7A and 7B, the control channels 701, 703, 705 extend parallel to each other and perpendicular to the fluidic channels 707, 709, 711.

Each control channel 701, 703, 705 includes a pressure inlet 713, 715, 717, respectively, couplable to a pressure regulator (e.g., pneumatic pump 109 of FIG. 1) for controlling the pressure in each control channel 701, 703, 705 and, thereby, controlling a gap size in the fluidic channels as the membrane deflects into the fluidic channel. As illustrated in FIG. 7C, under equilibrium/default pressure conditions, the membranes of the pressure channels do not deflect into the fluidic channel and the fluidic channel is not obstructed. Controllably increasing the pressure in one or more of the control channels causes a membrane to deflect into the fluidic channel for dynamic constriction as discussed above.

In the example of FIGS. 7A, 7B, 7C, and 7D, the pressure in each of the three control channels 701, 703, 705 can be separately regulated. As a result, each control channel can provide a different dynamic constriction in a single control channel with a different gap width as illustrated in FIG. 7D. As discussed further below, this configuration can provide for multiple different DEP behaviors in a single fluidic channel (e.g., sorting particles by size). Furthermore, because the control channels 701, 703, 705 each extends across all three fluidic channels 707, 709, 711 as shown in FIG. 7B, the same combination of gap widths can be applied to multiple fluidic channels simultaneously. Although the example of FIGS. 7A, 7B, 7C, and 7D illustrates a configuration with three parallel fluid channels and three parallel control channels, other implementations may include more or fewer fluid channels and/or more or fewer control channels.

As discussed above, by regulating the pressure within the control channel, the dielectrophoresis system such as those described above are able to dynamically control/adjust the gap distance within the fluid channel. By doing so, the dielectrophoresis systems are able to controllably tune the DEP force (F_{DEP}) on particles moving through the fluid channel. The DEP force (F_{DEP}) on a spherical particle in a fluid channel of the dielectrophoresis system can be expressed by the equation:

F_{DEP}=2πr³ϵₘRe[ƒ_{CM}]∇|E|² (1)

where r is the radius of the particle, ϵₘ is the permittivity of the medium, and ∇|E|² is the gradient of the electrical field squared (i.e., V²/m³). Re[ƒ_{CM}] is the Clausius-Mossotti factor and is defined by the equation:

$$Re [ {f}_{CM} ] = \frac{{σ}_{p} - {σ}_{m}}{{σ}_{p} + 2 {σ}_{m}} \qquad ( 2 )$$

where σₘ is the medium permittivity and σₚ is the particle permittivity. In some situations (e.g., at relatively low frequencies), the Clasius-Mossotti factor can be calculated (or defined) based on medium conductivity and particle conductivity instead of medium permittivity and particle permittivity, respectively.

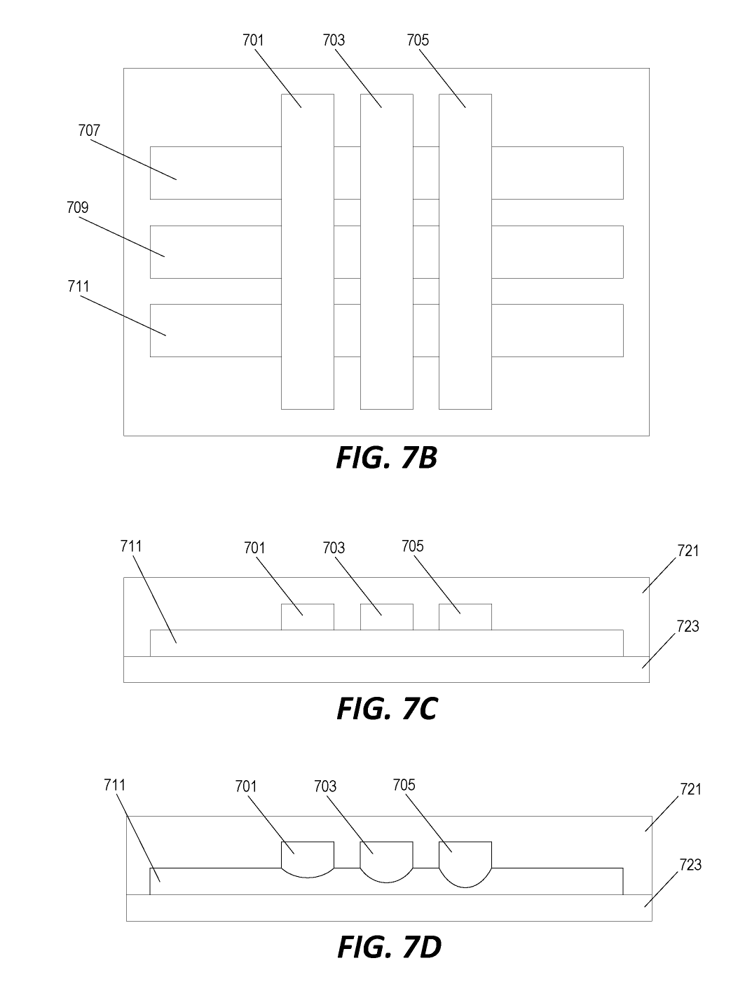

According to the equation above, the DEP force (F_{DEP}) is proportional to the gradient of the electrical field squared. The graph of FIG. 8 illustrates an example of how the gradient of the electrical field squared varies as the gap width of a fluid channel is adjusted by the pneumatic control channel in dielectrophoresis systems such as those described above. Because the pressure of the control channel can be controlled to dynamically adjust and regulate the gap width of the fluid channel, it can also be used to dynamically adjust and regulate the gradient of the electrical field and, in turn, the DEP force.

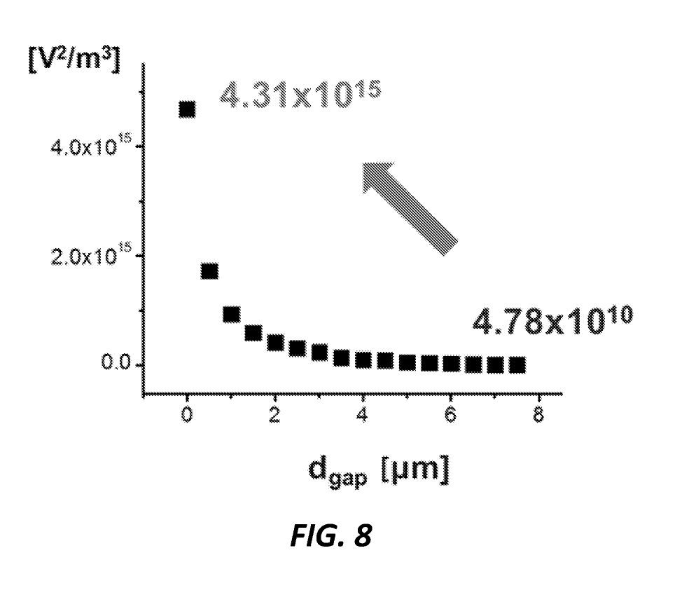

FIGS. 9A through 14D illustrate a number of examples using tunable IDEP induced by dynamic constriction using the systems described above. Other examples and uses are possible. Furthermore, although these examples generally discuss only a single fluid channel with a single dynamic constriction valve, other implementations may utilize multiple fluid channels and/or multiple constriction valve (e.g., using the system of FIGS. 7A, 7B, 7C, and 7D).

The example of FIGS. 9A through 9D illustrates the DEP behavior of 4.4 μm polysterene beads. In FIG. 9A, the pressure in the control channel is 0 mbar and 0V is applied to the fluidic channel. In FIG. 9B, 600Vₚₚ at 30 kHz has been applied to the fluidic channel, but the pressure of the control channel remains at 0 mbar. In FIG. 9C, 900 mbar pressure has been applied to the control channel with the 600Vₚₚ at 30 kHz applied to the fluid channel. Under these conditions, the polystyrene beads begin to form “pearl chains” as illustrated in further detail in FIG. 9D.

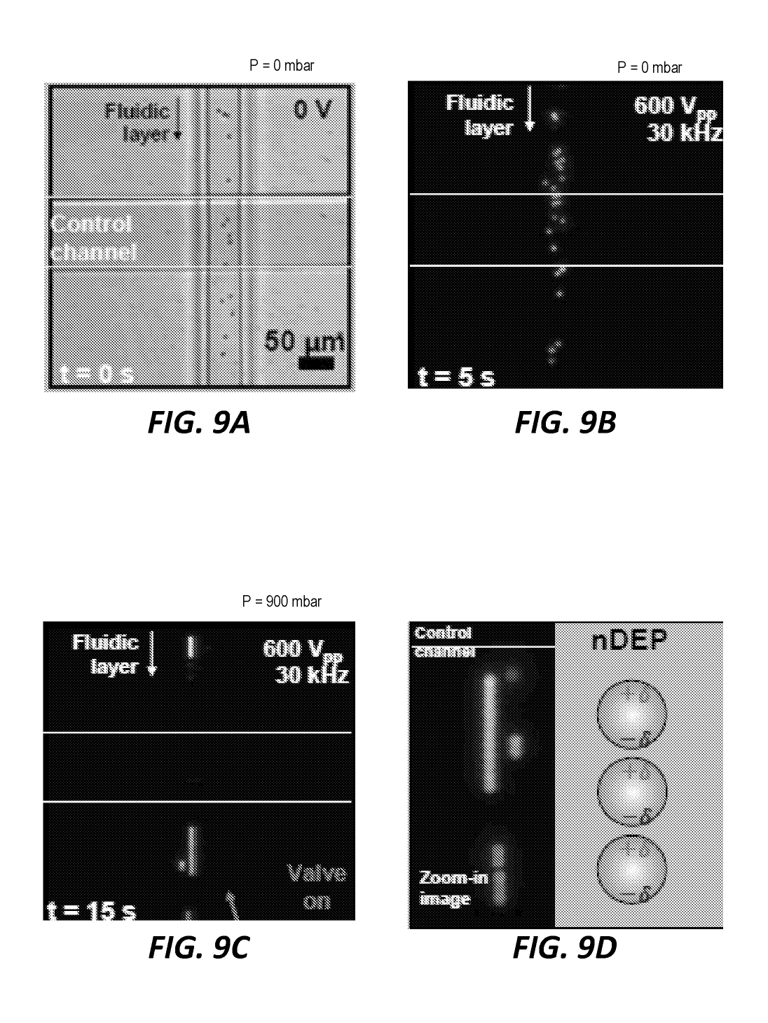

FIGS. 10A through 10D illustrate another example using smaller polystyrene beads with a diameter of 0.87 μm in the same dielectrophoresis system. FIG. 10A shows the fluid channel with 0V applied and the control channel at 0 mbar pressure. In FIG. 10B, 800Vₚₚ at 30 kHz is applied to the fluid channel and 900 mbar pressure is applied to the control channel. FIG. 10C shows the system 5 seconds later than FIG. 10B under the same conditions and, in FIG. 10D, the voltage has been removed from the fluid channel while the 900 mbar pressure is still applied to the control channel.

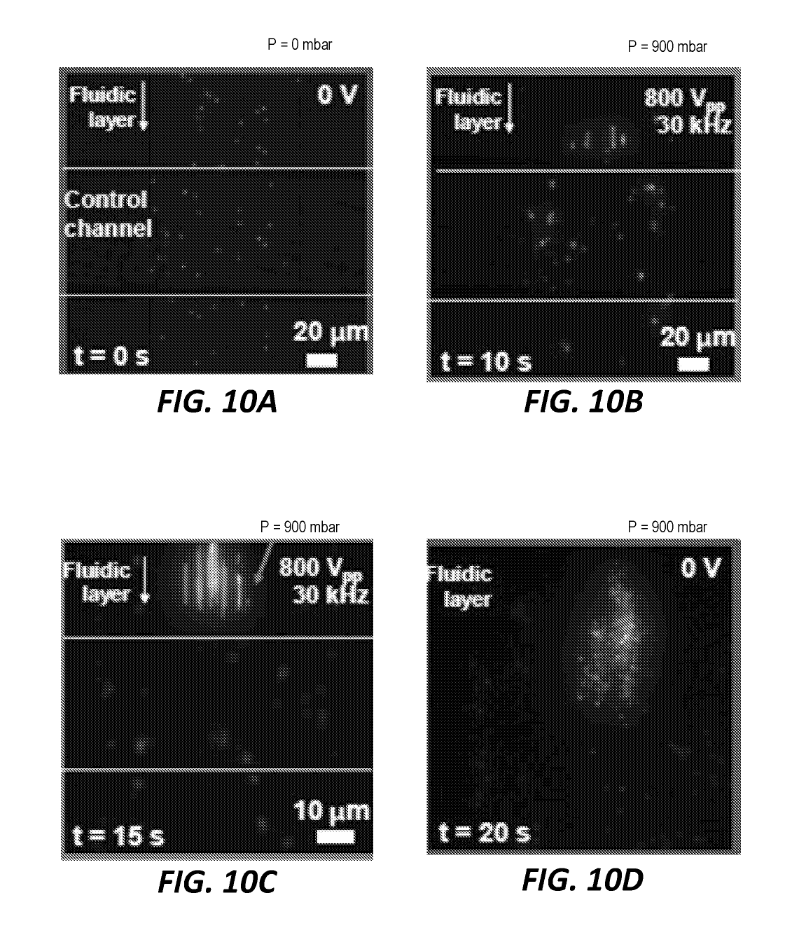

FIGS. 11A and 11B illustrate an example using the dynamic constriction valve for performing size selective particle sorting. In FIG. 11A, there is no actuation or deflection of the control channel 1103 and both the 280 nm particles and the larger 879 nm particles are able to move freely through the fluid channel 1101. However, when the dynamic constriction valve is actuated as shown in FIG. 11B, the larger particles remain on one side of the valve while the smaller particles are able to continue to move beyond the actuated constriction valve.

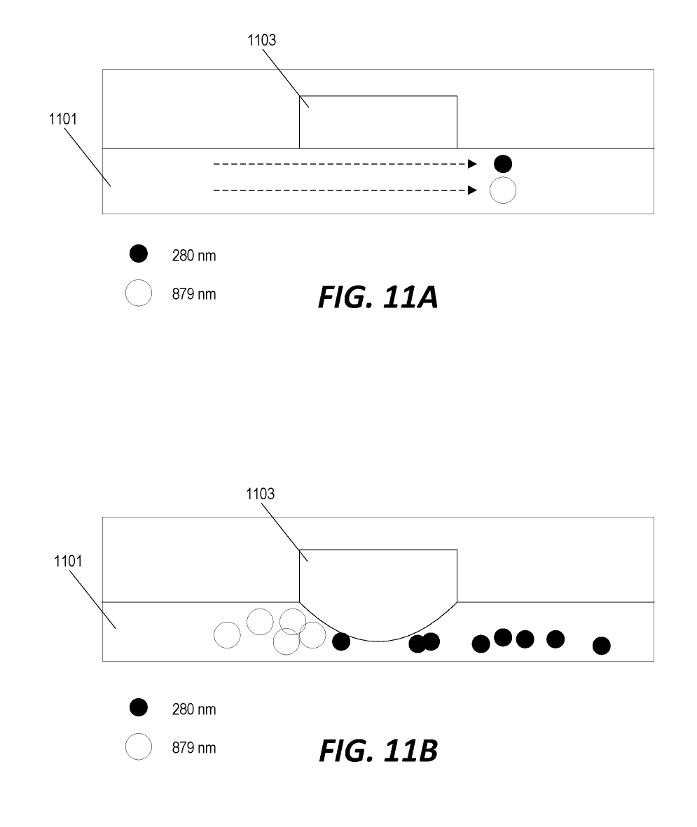

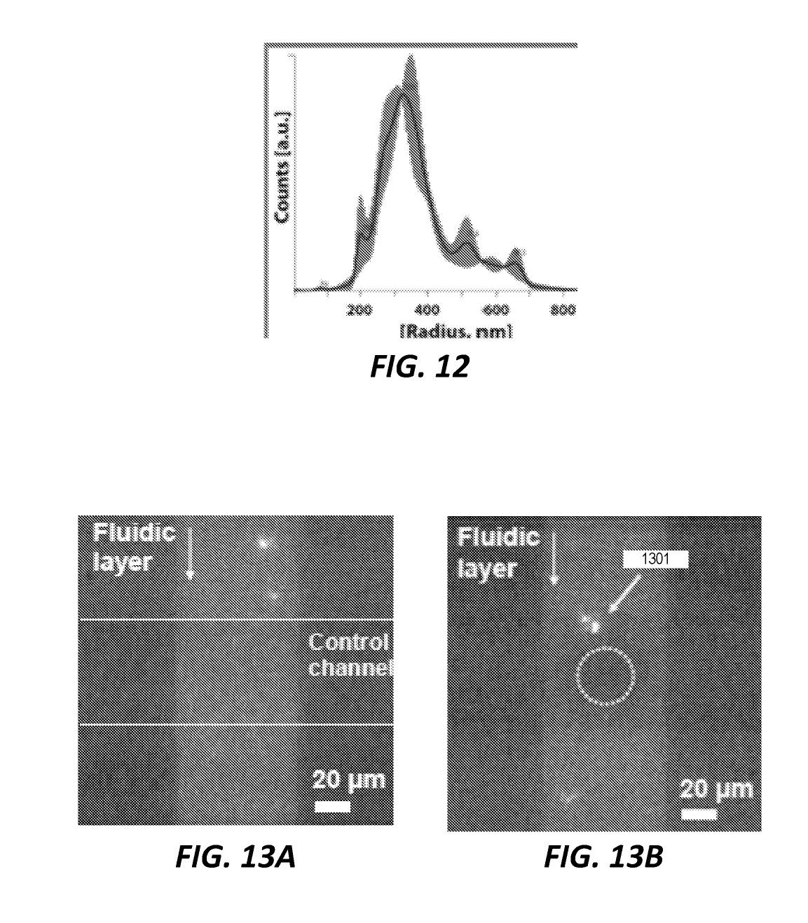

Tunable IDEP induced by dynamic constriction can also be used for liposome DEP and DNA DEP. FIG. 12 illustrates a graph of liposome sizes in a sample. FIG. 13A shows the sample in the fluid channel with 800Vpp/cm applied at 10 kHz with no valve actuation. FIG. 13B shows the same sample with the same voltage applied after the valve is actuated with 850 mbar pressure in the control channel. As shown in FIG. 13B, when the dynamic constriction valve is actuated, enriched liposomes accumulate near the deflected area (at 1301).

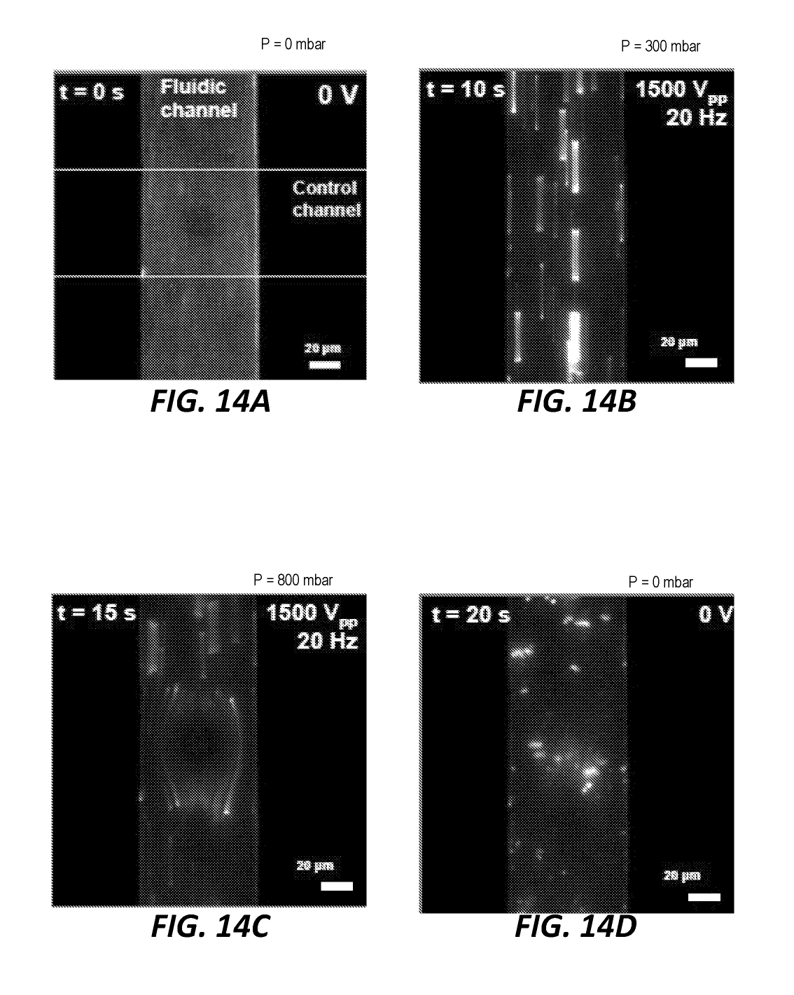

FIGS. 14A through 14D illustrate an example of DNA DEP. FIG. 14A shows the system at 0 s, FIG. 14B shows the system at 10 s, FIG. 14C shows the system at 15 s, and FIG. 14D shows the system at 20 s. At 0 s (i.e., FIG. 14A), the DNA sample is positioned in the fluid channel with no applied voltage and no pressure applied to the control channel. At 10 s (FIG. 14B), 1500Vₚₚ at 20 Hz has been applied to the fluid channel and 300 mbar pressure has been applied to the control channel to actuate the constriction valve. As shown in FIG. 14B, DNA “barbells” begin to form under the AC electric field under these conditions. At 15 s (FIG. 14C), the voltage of the fluid channel remains at 1500Vₚₚ at 20 Hz while the pressure in the control channel has been increased to 800 mbar to further deflect the constriction valve. As shown in FIG. 14C, enrichment of the DNA barbells is present under the deflected area showing unique hydrodynamic behavior of DNA. At 20 s (FIG. 14D), both the voltage on the fluid channel and the pressure in the control channel have been removed. FIG. 14D shows DNA cluster formation under these conditions.

The example of FIGS. 14A through 14D illustrates one example of using the IDEP system to subject DNA to DEP trapping. Since DNA trapping is dependent on DNA length, the IDEP systems and techniques discussed above could also be used to manipulate DNA by length or size (e.g., as illustrated in the example of FIGS. 11A and 11B above).

Furthermore, although the examples described above generally refer to dielectrophoresis, in some implementations, the system may be adapted and/or operated to perform electrophoresis (i.e., with a homogeneous electrical field) in addition to or instead of performing dielectrophoresis (i.e., with an electrical field gradient). Accordingly, unless otherwise specified, the phrase “electrophoresis system” used herein is used broadly to include systems used for performing electrophoresis with a homogeneous electrical field, for performing dielectrophoresis with an electrical field gradient, or both.

Thus, the invention provides, among other things, an insulator-based dielectrophoresis (iDEP) system where the electric field gradient is tuned by controllably constricting the fluidic channel by geometric deformation of an actuated membrane. Various features and advantages of the invention are set forth in the following claims.

1. A system for performing insulator-based dielectrophoresis (iDEP), the system comprising:
a fluidic layer defining a fluidic channel adjacent to a substrate;
a deformable membrane positioned adjacent to the fluidic channel;
an actuator configured to operate a dynamic constriction valve to variably restrict a fluidic flow in the fluidic channel, the dynamic constriction valve including the deformable membrane;
a control system configured to tune an electrical field gradient by operating the actuator to adjust a gap size of the fluidic channel at the dynamic constriction valve; and
a control layer positioned adjacent to the fluidic layer and including a control channel formed in the control layer, wherein the actuator includes a pneumatic pump coupled to the control channel and configured to adjust the gap size of the fluidic channel at the dynamic constriction valve by adjusting a pneumatic pressure within the control channel to control a deflection of the deformable membrane relative to the fluidic channel.

2. (canceled)

3. The system of claim 1, wherein the control system is configured to tune the electrical field gradient by adjusting the pneumatic pressure within the control channel to adjust the gap size of the fluidic channel.

4. The system of claim 1, wherein the actuator is configured to decrease the gap size of the fluidic channel by increasing the pneumatic pressure within the control channel to controllably cause the deformable membrane to deflect into the fluidic channel.

5. The system of claim 1, wherein the dynamic constriction valve further includes a pillar positioned within the fluidic channel at least partially blocking the fluidic channel, and wherein the actuator is configured to increase the gap size of the fluidic channel by decreasing the pneumatic pressure within the control channel to controllably cause the deformable membrane to deflect away from the fluidic channel.

6. The system of claim 5, wherein the pillar is fixedly coupled to the deformable membrane, and wherein deflection of the deformable membrane away from the fluidic channel increases the gap size of the fluidic channel between the pillar and the substrate.

7. The system of claim 5, wherein the pillar is fixedly coupled to the substrate, and wherein deflection of the deformable membrane away from the fluidic channel increases the gap size of the fluidic channel between the pillar and the deformable membrane.

8. The system of claim 1, wherein the control layer includes a plurality of control channels each forming a separate dynamic constriction valve at a different location along a length of the fluidic channel.

9. The system of claim 8, wherein the actuator is configured to independently adjust a gap size of the fluidic channel at each separate dynamic constriction valve by independently adjusting a pneumatic pressure within each control channel of the plurality of control channels to control a deflection of the deformable membrane relative to the fluidic channel at each separate dynamic constriction valve.

10. The system of claim 9, wherein the actuator is configured to
apply a first pneumatic pressure in a first control channel of the plurality of control channels to provide a first gap size at a first dynamic constriction valve due to deflection of the deformable membrane into the fluidic channel at the first dynamic constriction valve, and
apply a second pneumatic pressure in a second control channel of the plurality of control channels to provide a second gap size at a second dynamic constriction valve due to deflection of the deformable membrane into the fluidic channel at the second dynamic constriction valve, wherein applying a second pneumatic pressure that is greater than the first pneumatic pressure causes the second gap size to be smaller than the first gap size.

11. The system of claim 1, wherein the fluidic layer defines a plurality of fluidic channels adjacent to the substrate, wherein each fluidic channel of the plurality of fluidic channels is positioned parallel to other fluidic channels of the plurality of fluidic channels and extends from a first electrode to a second electrode.

12. The system of claim 11, wherein a voltage is applied to at least one fluidic channel of the plurality of fluidic channels between the first electrode and the second electrode.

13. The system of claim 11, wherein a first voltage is applied to a first fluidic channel of the plurality of fluidic channels and a second voltage is applied to a second fluid channel of the plurality of fluidic channels, wherein the first voltage is different than the second voltage.

14. A system for performing insulator-based dielectrophoresis (iDEP), the system comprising:
a fluidic layer defining a fluidic channel adjacent to a substrate;
a deformable membrane positioned adjacent to the fluidic channel;
an actuator configured to operate a dynamic constriction valve to variably restrict a fluidic flow in the fluidic channel, the dynamic constriction valve including the deformable membrane;
a control system configured to tune an electrical field gradient by operating the actuator to adjust a gap size of the fluidic channel at the dynamic constriction valve; and
a control layer positioned adjacent to the fluidic layer and including a control channel formed in the control layer, wherein the actuator includes a pneumatic pump coupled to the control channel and configured to adjust a pneumatic pressure in the control channel, and wherein the control channel is positioned across the plurality of fluidic channels and configured to cause deflections of the deformable membrane in each of the plurality of fluidic channels in response to changes in the pneumatic pressure,
wherein the fluidic layer defines a plurality of fluidic channels adjacent to the substrate, wherein each fluidic channel of the plurality of fluidic channels is positioned parallel to other fluidic channels of the plurality of fluidic channels and extends from a first electrode to a second electrode.

15. The system of claim 14, wherein applying a defined pneumatic pressure in the control channel causes deflections of the deformable membrane into each fluidic channel of the plurality of fluidic channels resulting in a same gap size in each fluidic channel.

16. The system of claim 1, wherein a fluidic channel includes particles of at least two different sizes, and wherein the control system is configured to sort the particles by size by adjusting the gap size of the fluidic channel at the dynamic constriction valve.

17. The system of claim 1, wherein the fluidic channel includes polystyrene beads with a diameter of 50 μm or less, and wherein the control system is configured to tune the electrical field gradient to cause the polystyrene beads to form into chains.

18. The system of claim 1, wherein the fluidic channel includes DNA material, and wherein the control system is configured to tune the electrical field gradient to form DNA barbells at the dynamic constriction valve.

19. The system of claim 1, wherein the fluidic channel includes liposomes, and wherein the control system is configured to tune the electrical field gradient to cause enriched liposomes to collect at a defined location in the fluidic channel.
